(19) United States
(12) Patent Application Publication
(10) Pub. No.: US 2019/0283067 A1
(43) Pub. Date: Sep. 19, 2019

(54) GRAVITY FED DIFFUSER

(71) Applicant: Gurunanda, LLC, Buena Park, CA (US)

(72) Inventors: Puneet Nanda, Beverly Hills, CA (US); Huy Kha Nguyen, Anaheim, CA (US)

(21) Appl. No.: 16/355,473

(22) Filed: Mar. 15, 2019

Related U.S. Application Data
(60) Provisional application No. 62/643,654, filed on Mar. 15, 2018.
(60) Provisional application No. 62/774,464, filed on Dec. 3, 2018.

(51) Int. Cl. B05B 17/06; B05B 15/62; B05B 15/68

(52) U.S. Cl. CPC B05B 17/06; B05B 15/68; B05B 15/62

(57) ABSTRACT

A diffuser for a liquid including a body including an opening for receiving the liquid in a container. An ultrasonic vaporizer is configured to vaporize the liquid received from the container into a vapor that is emitted from the body. A channel extends from the opening to the ultrasonic vaporizer and is configured to convey the liquid received from the container to the ultrasonic vaporizer with a gravity feed. The channel does not include any absorbent material. A power port is coupled to the body and configured to provide power to the ultrasonic vaporizer.

### CROSS-REFERENCE TO RELATED APPLICATIONS

This application claims the benefit of U.S. Provisional Application No. 62/643,654, filed Mar. 15, 2018, and U.S. Provisional Application No. 62/774,464, filed Dec. 3, 2018, the entire contents of these applications being incorporated by reference herein.

### BACKGROUND

Diffusers have been utilized to emit vapor into a surrounding area, for aromatherapy purposes or other therapeutic purposes. These diffusers, however, utilize a wick or other absorbent material to draw liquid from a container to be vaporized and emitted from the diffuser. These diffusers suffer from a series of drawbacks, including clogging of the absorbent material or reduced potency of the vapor emitted by the diffuser. In addition, these diffusers do not utilize a gravity feed to deliver liquid from a container to be vaporized, which reduces their efficiency.

Improvements in diffusers, to enhance pathways to deliver liquid from a container to be vaporized, are accordingly desired. Improvements in portable diffusers are also desired.

### SUMMARY

Apparatuses, systems, and methods disclosed herein include a diffuser for a liquid comprising a body including an opening for receiving the liquid in a container. An ultrasonic vaporizer is configured to vaporize the liquid received from the container into a vapor that is emitted from the body. A channel extends from the opening to the ultrasonic vaporizer and is configured to convey the liquid received from the container to the ultrasonic vaporizer with a gravity feed, the channel not including any absorbent material. A power port is coupled to the body and configured to provide power to the ultrasonic vaporizer.

Apparatuses, systems, and methods disclosed herein include a diffuser for a liquid comprising a body including an opening for receiving the liquid in a container. An ultrasonic vaporizer is configured to vaporize the liquid received from the container into a vapor that is emitted from the body. A channel has a first end and a second end, the first end being at the opening and the second end being at the ultrasonic vaporizer, the channel being configured to convey the liquid received from the container to the ultrasonic vaporizer with the force of gravity, the channel from the first end to the second end not including any absorbent material. A power port is coupled to the body and configured to provide power to the ultrasonic vaporizer.

Apparatuses, systems, and methods disclosed herein include a method comprising providing a portable diffuser. The portable diffuser includes: a body having a receiver for receiving a container that is separable from the body, and the body having an opening for receiving liquid from the container; an ultrasonic vaporizer; and a channel extending from the opening to the ultrasonic vaporizer and configured to convey the liquid from the container to the ultrasonic vaporizer. The method includes dispensing the liquid from the container through the channel and to the ultrasonic vaporizer with a gravity feed; and vaporizing the liquid with the ultrasonic vaporizer to form a vapor that is emitted from the body.

### BRIEF DESCRIPTION OF THE DRAWINGS

Features and advantages of the systems, apparatuses, and methods as disclosed herein will become appreciated as the same become better understood with reference to the specification, claims, and appended drawings wherein:

FIG. 1 illustrates a front view of a diffuser and a container according to an embodiment of the present disclosure.

FIG. 2 illustrates a side view of the diffuser shown in FIG. 1.

FIG. 3 illustrates a top perspective view of the first end of the diffuser shown in FIG. 1.

FIG. 4 illustrates a top view of the diffuser shown in FIG. 1.

FIG. 5 illustrates a front perspective view of the diffuser shown in FIG. 1 with a container coupled thereto.

FIG. 6 illustrates an exploded perspective view of the diffuser shown in FIG. 1.

FIG. 7 illustrates a perspective view of an inner surface of the front shell of the diffuser shown in FIG. 1.

FIG. 8 illustrates a cross-sectional view along line I-I in FIG. 4 of the first end of the diffuser shown in FIG. 1.

FIG. 9 illustrates a cross-sectional view along line I-I in FIG. 4 of the first end of the diffuser shown in FIG. 1 with a container coupled thereto.

FIG. 10 illustrates a perspective view of an adaptor according to an embodiment of the present disclosure.

FIG. 11 illustrates a front view of a diffuser according to an embodiment of the present disclosure.

FIG. 12 illustrates a side view of the diffuser shown in FIG. 11.

FIG. 13 illustrates a rear view of the diffuser shown in FIG. 11.

FIG. 14 illustrates a perspective view of a diffuser according to an embodiment of the present disclosure.

FIG. 15 illustrates a perspective view of the diffuser shown in FIG. 14.

FIG. 16 illustrates a close-up view of the diffuser shown in FIG. 14.

### DETAILED DESCRIPTION

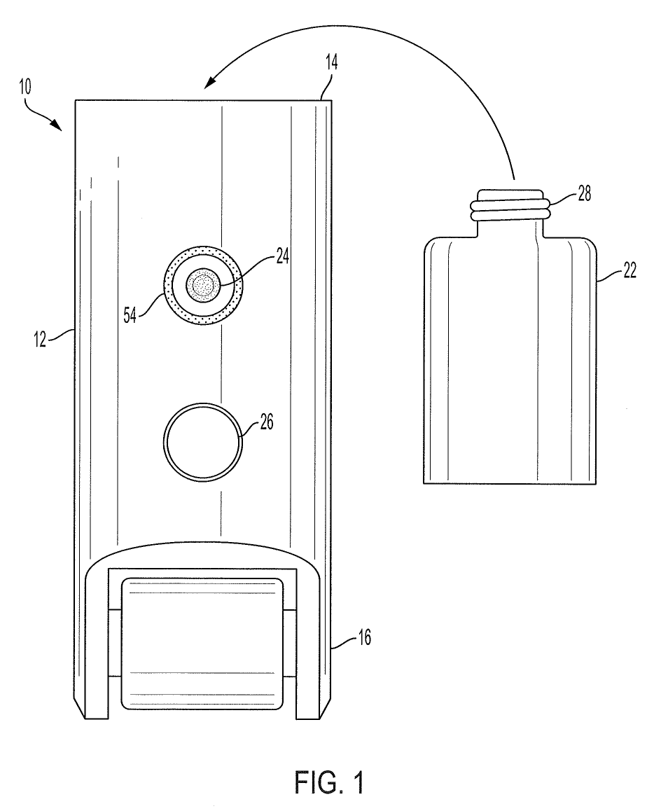

FIG. 1 illustrates a front view of a diffuser 10 according to an embodiment of the present disclosure. The diffuser 10 includes a body 12 with a first end 14 and a second end 16 and a length therebetween. The body 12 has a cylindrical shape.

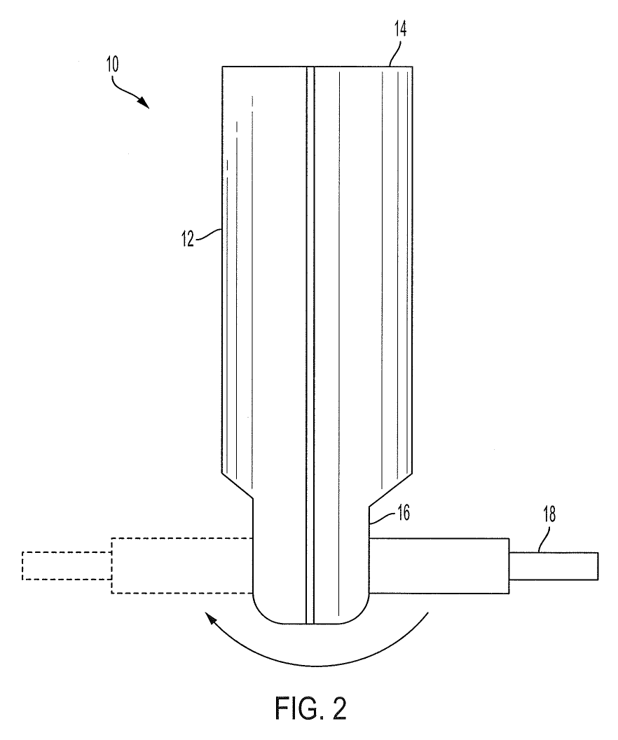

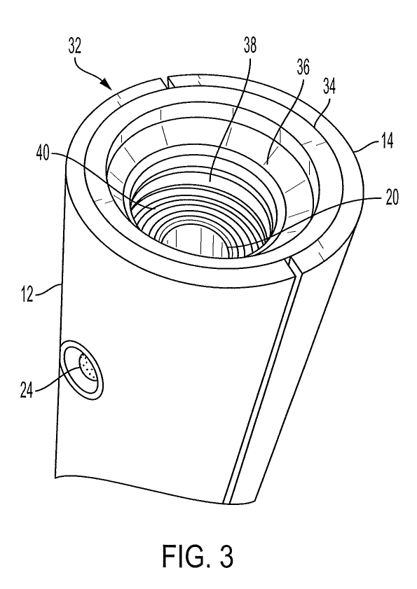

A power port 18 (shown in FIG. 2) is coupled to the body 12 and is positioned at the second end 16 of the body 12. The first end 14 of the body 12 includes an opening 20 (shown in FIG. 3) for receiving liquid in a container 22 that is separable from the body 12.

The diffuser 10 includes an ultrasonic vaporizer 24 that is configured to vaporize the liquid received from the container 22 into a vapor that is emitted from the body 12. The diffuser 10 may also include an actuator 26 that is configured to be actuated by a user to operate the diffuser 10, such as by activating the ultrasonic vaporizer 24 (e.g., turning the ultrasonic vaporizer 24 on or off, or modifying an operation mode of the ultrasonic vaporizer 24) or by performing other functions of the diffuser 10 (e.g., turning a light or off, or other functions of the diffuser 10).

A container 22 may be utilized with the diffuser 10. The container 22 may be configured to hold liquid therein. The liquid is preferably an oil, such as an essential oil or other form of extract, or in other embodiments may be other forms of liquids including but not limited to suspensions or the like. The liquid may be a fragrance oil or other fragrant substance. The liquid may be configured to be vaporizable to form a vapor that is emitted from the diffuser 10. A liquid such an essential oil may produce a fragrance in the emitted area, and may be utilized for aromatherapy purposes or other purposes. The container 22 may be configured to be separable from the body 12. In one embodiment, a container may be fixed to the body 12.

The container 22 may be configured to be the container that the liquid is stored in, and/or may comprise the packaging that the liquid is sold in. As such, multiple containers carrying varying types of liquid may be interchanged with each other and utilized with the diffuser 10. For example, in an embodiment in which the liquid is an essential oil, a certain container may contain a certain type of essential oil. Another container may contain another type of essential oil. The two containers may both be interchangeably utilized with the diffuser 10. The containers may be the respective containers that the essential oils are stored in, and/or may comprise the packaging that the respective essential oils are sold in. As such, a user may be able to purchase containers of the liquids (e.g., essential oils) from a merchant and utilize them with the diffuser 10 without having to transfer the liquids to another container that is dedicated to the diffuser 10. The transfer of liquids is accordingly reduced and the user may more quickly utilize the liquid vapor for aromatherapy purposes or other purposes. In addition, the reduced transfer of liquids may allow the liquid to be conserved (e.g., not spilt or otherwise lost during transfer of the liquid), and may reduce cross-contamination of the liquid with other types of liquid that may have previously been used in a container that was dedicated for use with the diffuser 10.

In other embodiments, the diffuser 10 may utilize a dedicated container to hold the liquid. The dedicated container may be separable from the body 12. In one embodiment, the dedicated container may be fixed to the body 12.

As shown in FIG. 1, the container 22 may comprise a bottle. The bottle may include threading 28 for coupling the bottle to the body 12 of the diffuser 10. The threading 28 may be positioned at the neck of the bottle. The container 22 accordingly may be separable from the body 12 by being screwed on or off of the body 12.

As represented by the arrow in FIG. 1, the container 22 may be overturned in order to couple with the body 12 of the diffuser 10. The container 22 accordingly may dispense the liquid contained therein to the diffuser 10 with a gravity feed. The force of gravity may pull on the liquid to draw the liquid to the ultrasonic vaporizer 24, where it is vaporized into a vapor that it is emitted from the body 12. Thus, the liquid's own weight comprises the method of conveying the liquid to the ultrasonic vaporizer 24.

FIG. 2 illustrates a side view of the diffuser 10. The power port 18 is shown extending at an angle relative to the length of the body 12. The power port 18 may be configured to connect to an external power source such as a wall socket, or a universal serial bus (USB) terminal or the like. The power port as shown in FIG. 2 comprises a USB port. In other embodiments, other forms of power ports such as pronged terminals (e.g., AC prongs) or car charger terminals, micro-USB terminals, or other forms of connectors may be utilized. The power port 18 may be configured to provide power to the components of the diffuser 10, including the ultrasonic vaporizer 24 and other components (e.g., electrical components) of the diffuser 10.

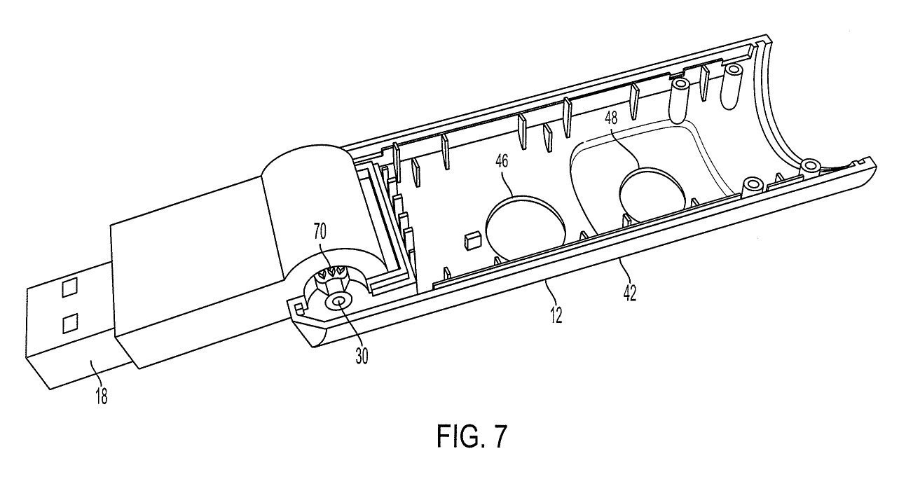

The power port 18 may be configured to pivot relative to the body 12, and accordingly parts of the body 12 such as the opening 20. The power port 18 may be configured to pivot at about 180 degrees relative to the body 12 and may be positioned at various points in between the 180 degree end positions of the power port 18 (e.g, held at various positions of 30 degrees, 45 degrees, 60 degrees, etc.). The dashed lines in FIG. 2 represent the movement of the power port 18. A pivot 30 (shown in FIG. 7) may couple the power port 18 to the body 12 and allow the power port 18 to pivot relative to the body 12.

The power port 18 may be configured to pivot such that a container 22 attached to the diffuser 10 remains upright or otherwise continues to allow for a gravity feed of liquid to the ultrasonic vaporizer 24. As such, if the external power source is at an angle relative to the body 12, then the power port 18 may pivot to connect with the external power source and assure that the container 22 attached to the diffuser 10 remains upright or otherwise continues to allow for a gravity feed of liquid to the ultrasonic vaporizer 24.

The power port 18 is shown to pivot about an axis extending perpendicular to the length of the body 12, however in other embodiments other directions of pivot may be utilized.

FIG. 3 illustrates a top perspective view of the first end 14 of the diffuser body 12. The first end 14 includes a receiver 32 for receiving the container 22. The receiver 32 may include an upper flat portion 34, a tapered portion 36, and a threaded portion 38. The body 12 may also include the opening 20 and a sealing surface 40 that surrounds the opening 20 and is configured to form a liquid-tight seal with the container 22. The threaded portion 38 may include threading for coupling the container 22 to the body 12.

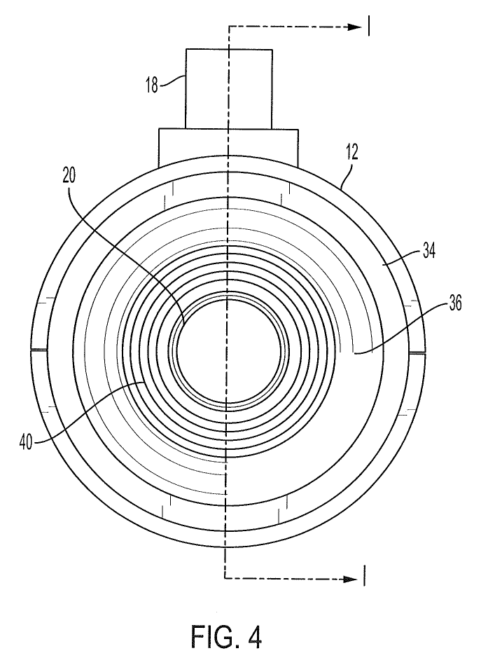

FIG. 4 illustrates a top view of the first end 14 of the diffuser body 12.

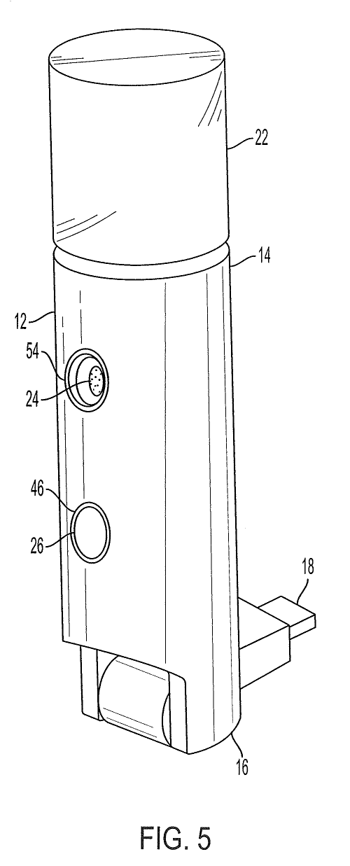

FIG. 5 illustrates a front perspective view of the diffuser 10 with the container 22 coupled thereto. The container 22 is shown to be inverted and received by the receiver 32 (shown in FIG. 3).

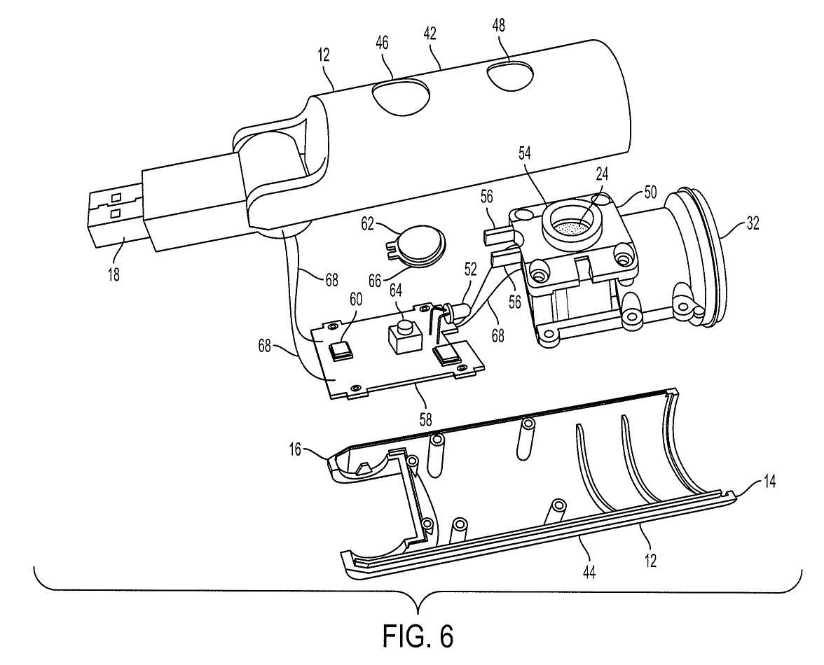

FIG. 6 illustrates an exploded perspective view of the diffuser 10. The body 12 may comprise a housing that contains components therein. The body 12 may include one or more shells, such as a front shell 42 and a rear shell 44 that contain components therein. An outer surface of the respective shells 42, 44 may form the outer surface of the body 12. Apertures in the shells may allow components of the diffuser to extend therethrough. The front shell 42 and rear shell 44 form the sidewalls of the body 12.

The front shell 42 may include a first aperture 46 for the actuator 26 to pass through. The front shell 42 may include a second aperture 48 for vapor from the ultrasonic vaporizer 24 to pass through the shell 42.

The front shell 42 and rear shell 44 may be joined together to contain the components therein.

The receiver 32 is part of the body 12 (although it may not be integral with the shells 42, 44) and may comprise shells that are joined together, in a similar manner as front shell 42 and rear shell 44. Front shell 42 and rear shell 44 may extend around the receiver 32 to hold the receiver 32 in position.

The ultrasonic vaporizer 24 may be coupled to the receiver 32 and positioned to emit vapor through the second aperture 48 of the front shell 42.

A light diffuser 50 may be coupled to the receiver 32 and may be configured to diffuse light received from a light source 52. The light diffuser 50 may have a raised portion 54 that extends through the second aperture 48 of the front shell 42. The raised portion 54 may allow the light from the light source 52 to be visible outside the body 12, and such light may indicate whether the diffuser 10 is operable, or if it is operating in a certain mode of operation, or may indicate another feature of the diffuser 10. Prongs 56 may extend from the light diffuser 50 and may extend around and adjacent to the light source 52 to receive and diffuse the light from the light source 52. The light source 52 may comprise a light-emitting diode (LED) or other forms of light sources such as an incandescent bulb or the like. The light source 52 may be configured to emit multiple colors of light or flash, which may indicate an operation status of the diffuser 10, such as when the diffuser 10 is on (or off), or the time interval at which vapor will be emitted from the diffuser 10.

A printed circuit board 58 may be housed between the front shell 42 and the rear shell 44. The printed circuit board 58 may include circuitry for operating the functions of the diffuser 10, including but not limited to operating the ultrasonic vaporizer 24 and/or the light source 52. The printed circuit board 58 may include circuitry for transferring power from the power port 18 to the ultrasonic vaporizer 24 and/or the light source 52. The light source 52 may be coupled to the printed circuit board 58. The printed circuit board 58 may include a timer circuit 60 that controls timed release of vapor from the ultrasonic vaporizer 24. For example, the timer circuit 60 may cause the release of vapor at a predetermined time by operating the ultrasonic vaporizer 24 at a predetermined time. The predetermined time may be a release of vapor every 10 minutes, or every 20 minutes, every 30 minutes, every hour, among other time periods. The time periods may be set as desired.

The actuator 26 (marked in FIG. 1) may comprise one or more components. In FIG. 6, the actuator includes a push surface 62 and a button 64. The push surface 62 may extend through the first aperture 46, and may be configured for a user to push. A flanged portion 66 of the push surface 62 may extend outward from the push surface 62 to prevent the push surface 62 from passing through the front shell 42. The button 64 may be positioned adjacent, or behind, the push surface 62 and may provide resiliency to hold the push surface 62 in position. The button 64 may comprise an electrical push button that is pressed when the push surface 62 is pressed by a user (and correspondingly presses against the button 64). The user may press the push surface 62 (and button 64) to operate the diffuser 10, such as by activating the ultrasonic vaporizer 24 (e.g., turning the ultrasonic vaporizer 24 on or off, or modifying an operation mode of the ultrasonic vaporizer 24) or by performing other functions of the diffuser 10 (e.g., turning the light source 52 or off, changing the color of the light source 52 or other functions of the diffuser 10). The user may press the push surface 62 (and button 64) to operate the timer circuit 60 and vary or select the predetermined time that vapor is emitted by the ultrasonic vaporizer 24.

Electrical connectors 68, such as wires, may connect the electrical components of the diffuser 10. Electrical connectors 68 may extend from the power port 18 to the printed circuit board 58 to provide power to the electrical components on the printed circuit board 58 (such as the light source 52 and timer circuit 60). Electrical connectors 68 may extend from the printed circuit board 58 to the ultrasonic vaporizer 24 to provide power to the ultrasonic vaporizer 24 from the power port 18, and to operate the ultrasonic vaporizer 24 in a desired manner, such as emitting vapor at a desired time.

FIG. 7 illustrates a perspective view of the inner surface of the front shell 42. The power port 18 couples to the body 12 with a pivot 30. The pivot 30 may comprise a housing that holds an end of the power port 18 and allows the power port 18 to pivot about an axis. A detent including multiple pins 70 may be utilized to hold the power port 18 at a desired angle relative to the body 12.

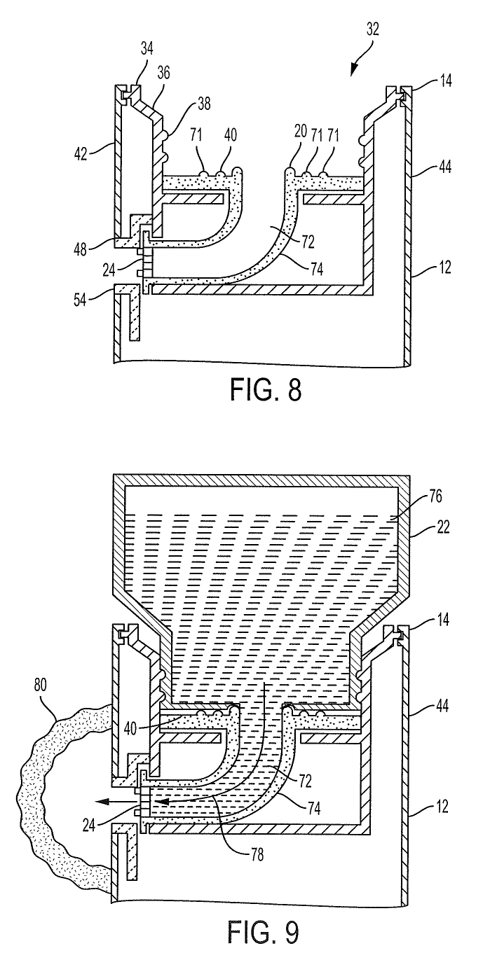

FIG. 8 illustrates a cross sectional view of the first end 14 of the diffuser body 12 along line I-I in FIG. 4. The upper flat portion 34, tapered portion 36, and threaded portion 38, are each shown in cross sectional view. The sealing surface 40 is also shown in cross sectional view, with small ridges 71 shown in the sealing surface 40 to enhance the liquid-tight seal with a container. The sealing surface 40 surrounds the opening 20.

The opening 20 for receiving the liquid in the container is shown in the center of the receiver 32. The opening 20 is positioned at an end of a channel 72 that extends from the opening 20 to the ultrasonic vaporizer 24. The channel 72 is configured to convey the liquid received from a container to the ultrasonic vaporizer 24 with a gravity feed. The force of gravity may pull on the liquid to draw the liquid to the ultrasonic vaporizer 24 through the channel 72, where it is vaporized into a vapor that it is emitted from the front shell 42. Thus, the liquid's own weight comprises the method of conveying the liquid to the ultrasonic vaporizer 24. Notably, the channel 72 does not include any absorbent material. A siphon or wicking process is not utilized to transfer the liquid from the container to the ultrasonic vaporizer 24. No capillary action is utilized to transfer the liquid from the container to the ultrasonic vaporizer 24. A cotton wick or swab, or other absorbent material is not utilized to transfer the liquid from the container to the ultrasonic vaporizer 24. A cotton wick or swab, or other absorbent material is not positioned in the container or the channel 72. Rather, the liquid's own weight comprises the method of conveying the liquid to the ultrasonic vaporizer 24.

The lack of any absorbent material provides multiple benefits. A benefit is that absorbent material may be clogged or otherwise become dirty, which will impede or defeat the use of the diffuser. Another benefit is that the absorbent material may reduce the potency of a liquid passing therethrough, because the absorbent material may absorb particles that should be otherwise emitted by the ultrasonic vaporizer 24. This may be pertinent if a liquid such as an essential oil or liquid with particulate matter is to be emitted from the ultrasonic vaporizer 24. The absorbent material may reduce the potency of such an emission. As such, enhanced operation (reduced clogging and enhanced potency) and cost savings (reducing the number of times the absorbent material needs to be replaced) may be realized through lack of any absorbent material. Also, the use of a gravity feed provides benefits over a siphon, wicking, or capillary process. The use of a gravity feed enhances the direct flow of liquid to the surface of the ultrasonic vaporizer 24. The direct connection of the opening 20 to the ultrasonic vaporizer 24 as shown in FIG. 8 prevents the liquid from having to pass through an intermediate material, and enhances the direct flow of liquid to the surface of the ultrasonic vaporizer 24.

The channel 72 is defined by a wall 74 that extends around the channel 72. The wall 74 may be integral with the sealing surface 40. The wall 74 may be made of a rubber or plastic material, or other non-absorbent material, and the sealing surface 40 accordingly may be made of a rubber or plastic material, or other non-absorbent material. The channel 72 may have a tube-like shape extending from the opening 20 to the ultrasonic vaporizer 24.

The channel 72 may curve from the end of the channel 72 at the opening 20 to the end of the channel 72 at the ultrasonic vaporizer 24. The channel 72 may curve at about ninety degrees, as shown in FIG. 8. The channel may define a flow path for the liquid passing therethrough that curves, such that a direction of flow at the ultrasonic vaporizer 24 is perpendicular to the direction of flow at the opening 20, as shown in FIG. 8. The direction of flow at the ultrasonic vaporizer 24 may also be perpendicular to the longitudinal axis that the body 12 extends along. In other embodiments, the channel may define other shapes of curves or paths from the opening 20 to the ultrasonic vaporizer 24. For example, the channel 72 may curve at an angle that is different than 90 degrees (e.g. 80, 70, 60, etc. degrees).

The ultrasonic vaporizer 24 may comprise a plate having micro-apertures, as shown in FIG. 8. The ultrasonic vaporizer 24, when powered, may vary in shape and vibrate, causing the liquid adjacent to the ultrasonic vaporizer 24 to be drawn through the micro-apertures and emitted as a vapor. The ultrasonic vaporizer 24 may operate as a piezoelectric vaporizer. The direct contact of the gravity fed liquid to a surface of the ultrasonic vaporizer 24 allows the ultrasonic vaporizer to efficiently vaporize and emit the resulting vapor from the body. In other embodiments, other forms of ultrasonic vaporizers may be utilized. In other embodiments, other emitter devices may be utilized.

FIG. 9 illustrates a cross sectional view of the first end 14 of the diffuser body 12 along line I-I in FIG. 4, with the container 22 coupled to the first end 14 of the diffuser body 12. The container 22 is shown to be screwed to the diffuser body 12 and a liquid-tight seal is formed with the sealing surface 40. The liquid 76 is gravity fed to the ultrasonic vaporizer 24 through the channel 72 and does not contact any absorbent material. The flow path 78 of the liquid curves about ninety degrees to the ultrasonic vaporizer 24. The ultrasonic vaporizer 24 directly contacts the liquid 76 and vaporizes the liquid 76 received from the container 22 into a vapor 80 that is emitted from the body 12.

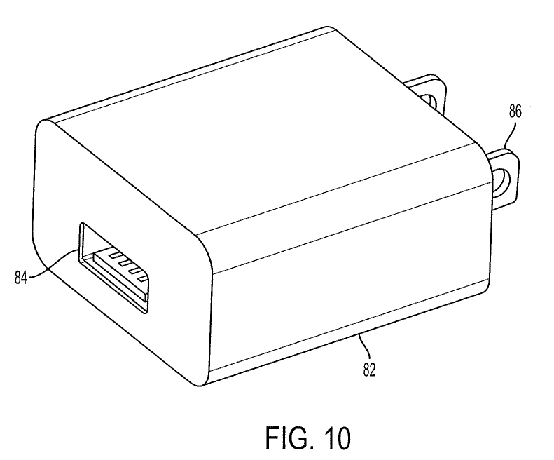

FIG. 10 illustrates an adaptor 82 that may be utilized with the diffuser 10 for coupling to the power port 18. The adaptor 82 may include a female port 84, which may receive the power port 18 and may comprise a female USB port. The adaptor 82 may include a male port 86, which may comprise power prongs (such as AC power prongs). The male port 86 may couple to a power source, such as a wall socket. The adaptor 82 may allow the diffuser 10 to draw power from a variety of different forms of power sources. The adaptor 82 may enhance the versatility of the diffuser 10. Other forms of adaptors (e.g., car charger adaptors, micro USB adaptors) may be utilized as desired. In certain embodiments, the adaptor may not be utilized.

The diffuser 10 may be portable, and may be sized to be hand-held. As such, a user may carry the diffuser 10 with them and install it into a desired power source. The user may position the power port such that the body 12 of the diffuser is upright or otherwise positioned so that the gravity feed of the diffuser 10 will work. The lack of absorbent material provides multiple benefits as disclosed herein. In other embodiments, an internal power source (e.g., a battery or capacitor), may be utilized to power the diffuser 10.

The diffuser 10 may be utilized for aromatherapy purposes, or may be utilized for other therapeutic purposes.

The diffuser 10 may be provided in combination with a container 22, and a system of the combination of diffuser 10 and container 22 may result.

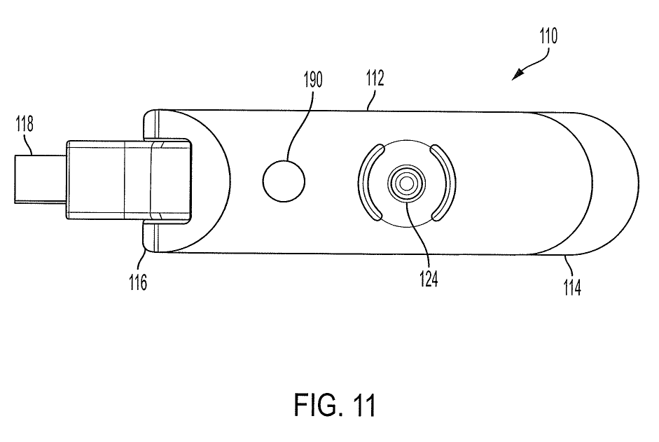

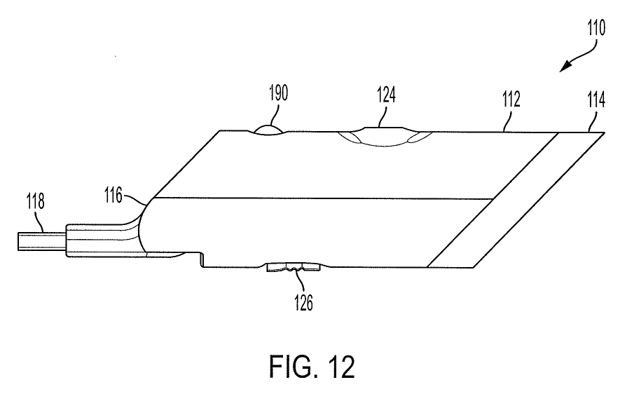

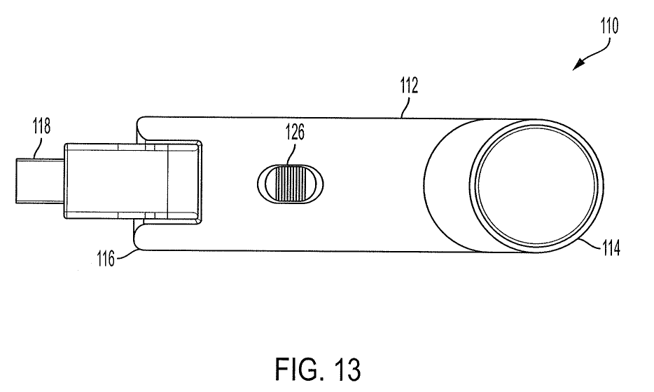

FIGS. 11-13 illustrate a diffuser 110 according to an embodiment of the present disclosure. The diffuser 110 is similar to the diffuser 10, and like parts include a similar reference number incremented by 100.

The diffuser 110 includes a body 112 with a first end 114 and a second end 116 and a length therebetween. The body 112 has a cylindrical shape. The body 112 may be configured similarly as the body 12 discussed in regard to FIGS. 1-9. The diffuser 110 includes a power port 118 coupled to the body 112 and is positioned at the second end 116 of the body 112. The power port 118 may be configured similarly as the power port 18 discussed in regard to FIGS. 2 and 4-7.

The diffuser 110 includes an ultrasonic vaporizer 124. The ultrasonic vaporizer 124 may be configured similarly as the ultrasonic vaporizer 24 discussed in regard to FIGS. 1, 3, 5-6, and 8-9. The diffuser 110 includes an actuator 126. The actuator 126 may be configured similarly as the actuator 26 discussed in regard to FIGS. 1 and 5. As depicted, the actuator 126 is in the form of a slide switch. However, other forms of actuators may be used according to various embodiments.

The diffuser 110 includes a motion detector 190 that is configured to cause or vary an operation of the ultrasonic vaporizer 124 based on motion being detected. The motion detector 190 may be positioned on the body 112 of the diffuser 110. The motion detector 190 may cause or vary an operation of the ultrasonic vaporizer 124 in a variety of manners. For example, the motion detector 190 may detect the motion of a person, animal, or object passing nearby and may cause the ultrasonic vaporizer 124 to vaporize the liquid based on motion being detected when the passage occurs. In another example, the motion detector 190 may operate to activate the diffuser 110 out of a “sleep” or “standby” mode when the passage occurs. The diffuser 110 may start a timer to cause the ultrasonic vaporizer 124 to vaporize the liquid based on motion being detected. In another example, the motion detector 190 may vary an operation of the ultrasonic vaporizer 124 when the passage occurs, for example, by increasing or decreasing a rate that the liquid vapor is emitted or by stopping emission of the liquid vapor.

In one embodiment, the motion detector 190 may cause or vary any operation of the diffuser 110, for example, by changing a color of light emitted by the diffuser 110 or another feature of the diffuser 110.

The motion detector 190 may be coupled to a printed circuit board, similar to the printed circuit board 58 (shown in FIG. 6), and/or the body 112. The printed circuit board may include circuitry for operating the motion detector 190. The printed circuit board may include circuitry for transferring power from the power port 118 to the motion detector 190.

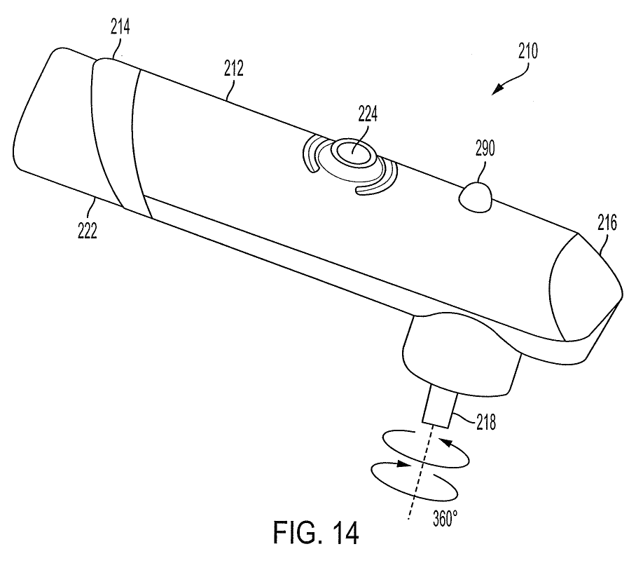

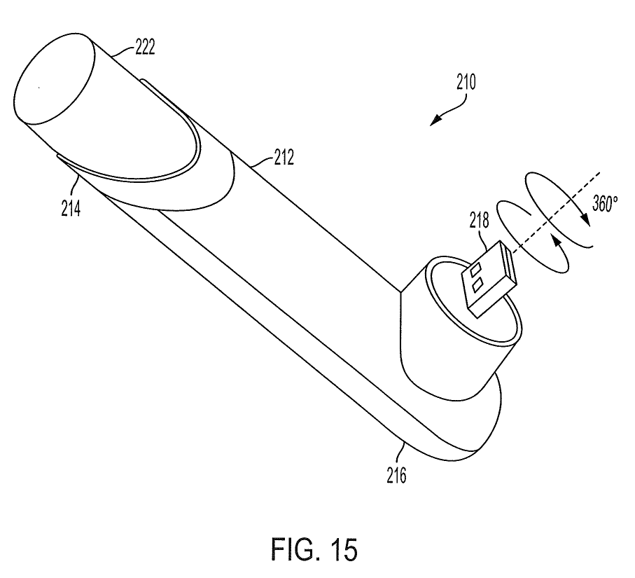

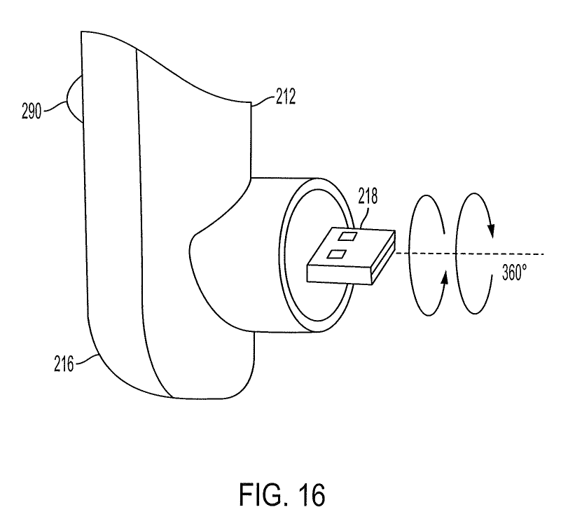

FIGS. 14-16 illustrate a diffuser 210 according to an embodiment of the present disclosure. The diffuser 210 is similar to diffuser 10, and like parts include a similar reference number incremented by 200.

The diffuser 210 includes a body 212 with a first end 214 and a second end 216 and length therebetween. The body 212 has a cylindrical shape. The body 212 may be configured similarly as body 12 discussed in regard to FIGS. 1-9. The diffuser 210 includes a power port 218 coupled to the body 212. The power port 218 may be positioned at the second end 216 of the body 212, yet in other embodiments may be positioned at different locations as desired. The power port 218 may be configured to rotate relative to the body 212. The power port 218 may be configured to rotate about an axis that the power port 218 extends along. The power port 218 may rotate in position about this axis. As represented by the arrows, the power port 218 may be configured to rotate 360 degrees relative to the body 212 in both clockwise and counterclockwise directions. The power port 218 may be positioned at various points along the 360-degree rotation (e.g., held at various positions at 30 degrees, 45 degrees, 60 degrees, etc.). The power port 218 is shown to rotate about an axis extending transverse to the length of the body 212, and as shown in FIGS. 14-16, the axis may extend perpendicular to the length of the body 212.

The diffuser 210 includes an ultrasonic vaporizer 224. The ultrasonic vaporizer 224 may be configured similarly as the ultrasonic vaporizer 24 discussed in regard to FIGS. 1, 3, 5-6, and 8-9.

The diffuser 210 may include a motion detector 290 that is configured to cause or vary an operation of the ultrasonic vaporizer 224 based on motion being detected, in a similar manner as discussed in regard to FIGS. 11-13. The motion detector 290 may be coupled to the body 212.

The scope of the disclosure herein is not limited to the apparatuses and systems disclosed herein, but additionally includes methods of utilizing the diffusers and other apparatuses and systems disclosed herein. The methods may include providing the apparatuses and systems disclosed herein, which may include having or supplying the apparatuses and systems disclosed herein. In one embodiment, a method may include providing a diffuser, which may be a portable diffuser. The diffuser may include a body having a receiver for receiving a container that is separable from the body, and the body having an opening for receiving liquid from the container. The diffuser may include an ultrasonic vaporizer, and a channel extending from the opening to the ultrasonic vaporizer and configured to convey the liquid from the container to the ultrasonic vaporizer. The method may include dispensing the liquid from the container through the channel and to the ultrasonic vaporizer with a gravity feed, and may include vaporizing the liquid with the ultrasonic vaporizer to form a vapor that is emitted from the body. The method may be varied or modified as desired, and steps may be added or removed from the method as desired. A method of utilizing the diffusers and other apparatuses and systems disclosed herein or performance of any of the steps disclosed in this application is within the scope of this disclosure.

The features of the various embodiments disclosed herein may be interchanged, substituted, modified, or varied as desired. For example, the motion detectors disclosed herein may be used with any embodiment, as well as the power port that may rotate about the axis it extends along. In one embodiment, the diffuser with the motion detector may not include a power port that may rotate about the axis it extends along. In one embodiment, the diffuser with the power port that may rotate about the axis it extends along may not include a motion detector. Other permutations across embodiments may be utilized as desired.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of systems, apparatuses, and methods as disclosed herein, which is defined solely by the claims. Accordingly, the systems, apparatuses, and methods are not limited to that precisely as shown and described.

Certain embodiments of systems, apparatuses, and methods are described herein, including the best mode known to the inventors for carrying out the same. Of course, variations on these described embodiments will become apparent to those of ordinary skill in the art upon reading the foregoing description. The inventor expects skilled artisans to employ such variations as appropriate, and the inventors intend for the systems, apparatuses, and methods to be practiced otherwise than specifically described herein. Accordingly, the systems, apparatuses, and methods include all modifications and equivalents of the subject matter recited in the claims appended hereto as permitted by applicable law. Moreover, any combination of the above-described embodiments in all possible variations thereof is encompassed by the systems, apparatuses, and methods unless otherwise indicated herein or otherwise clearly contradicted by context.

Groupings of alternative embodiments, elements, or steps of the systems, apparatuses, and methods are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses an approximation that may vary, yet is capable of performing the desired operation or process discussed herein.

The terms “a,” “an,” “the” and similar referents used in the context of describing the systems, apparatuses, and methods (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the systems, apparatuses, and methods and does not pose a limitation on the scope of the systems, apparatuses, and methods otherwise claimed. No language in the present specification should be construed as indicating any non-claimed element essential to the practice of the systems, apparatuses, and methods.

All patents, patent publications, and other publications referenced and identified in the present specification are individually and expressly incorporated herein by reference in their entirety for the purpose of describing and disclosing, for example, the compositions and methodologies described in such publications that might be used in connection with the systems, apparatuses, and methods. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

What is claimed is:

1. A diffuser for a liquid comprising:
a body including an opening for receiving the liquid in a container;
an ultrasonic vaporizer configured to vaporize the liquid received from the container into a vapor that is emitted from the body;
a channel extending from the opening to the ultrasonic vaporizer and configured to convey the liquid received from the container to the ultrasonic vaporizer with a gravity feed, the channel not including any absorbent material; and
a power port coupled to the body and configured to provide power to the ultrasonic vaporizer.

2. The diffuser of claim 1, wherein the body includes a sealing surface surrounding the opening that is configured to form a liquid-tight seal with the container.

3. The diffuser of claim 2, wherein the channel is defined by a wall extending around the channel.

4. The diffuser of claim 3, wherein the wall is integral with the sealing surface.

5. The diffuser of claim 1, wherein the channel includes a first end at the opening and a second end at the ultrasonic vaporizer, and the channel curves from the first end to the second end at about ninety degrees.

6. The diffuser of claim 1, wherein the body includes a first end, and a second end, and a sidewall between the first end and the second end, the opening being positioned at the first end, the power port being positioned at the second end, and the ultrasonic vaporizer being configured to emit the vapor from the sidewall of the body.

7. The diffuser of claim 1, wherein the diffuser is portable.

8. The diffuser of claim 1, further comprising a pivot coupling the power port to the body.

9. The diffuser of claim 1, wherein the body is configured to separably couple to the container.

10. The diffuser of claim 1, further comprising a motion detector configured to cause or vary an operation of the ultrasonic vaporizer based on motion being detected.

11. The diffuser of claim 10, further comprising an actuator configured to be actuated by a user to turn the ultrasonic vaporizer on or off.

12. The diffuser of claim 1, wherein the power port is configured to rotate about an axis that the power port extends along.

13. A diffuser for a liquid comprising:
a body including an opening for receiving the liquid in a container;
an ultrasonic vaporizer configured to vaporize the liquid received from the container into a vapor that is emitted from the body;
a channel having a first end and a second end, the first end being at the opening and the second end being at the ultrasonic vaporizer, the channel being configured to convey the liquid received from the container to the ultrasonic vaporizer with the force of gravity, the channel from the first end to the second end not including any absorbent material; and
a power port coupled to the body and configured to provide power to the ultrasonic vaporizer.

14. The diffuser of claim 13, wherein the channel defines a flow path for the liquid that curves such that the direction of flow at the second end of the channel is perpendicular to the direction of flow at the first end of the channel.

15. The diffuser of claim 13, wherein the body includes a sealing surface surrounding the opening that is configured to form a liquid-tight seal with the container.

16. The diffuser of claim 15, wherein the channel is defined by a wall extending around the channel, and the wall is integral with the sealing surface.

17. A method comprising:
providing a portable diffuser including:
a body having a receiver for receiving a container that is separable from the body, and the body having an opening for receiving liquid from the container,
an ultrasonic vaporizer, and
a channel extending from the opening to the ultrasonic vaporizer and configured to convey the liquid from the container to the ultrasonic vaporizer;
dispensing the liquid from the container through the channel and to the ultrasonic vaporizer with a gravity feed; and
vaporizing the liquid with the ultrasonic vaporizer to form a vapor that is emitted from the body.

18. The method of claim 17, wherein the channel does not include any absorbent material.

19. The method of claim 17, wherein the body includes a first end and a second end, the receiver being positioned at the first end of the body and a power port being positioned at the second end of the body.

20. The method of claim 19, wherein a pivot couples the power port to the body.
